(19) United States
(12) Patent Application Publication
(10) Pub. No.: US 2007/0099677 A1
(43) Pub. Date: May 3, 2007

(54) Data transfer method and transceiver thereof

(75) Inventors: Hong Kai Hsu, Taipei (TW); Sheng-Chung Chen, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/260,522

(22) Filed: Oct. 27, 2005

(51) Int. Cl. H04B 1/38

(52) U.S. Cl. 455/574; 370/311

(57) ABSTRACT

A data transfer method and transceiver of wireless communication. The transceiver of wireless communication comprises an antenna, and a receiving module. The antenna receives first data. The receiving module is coupled to the antenna, receives the first data, compares a source address of the first data with a desired address, determines first signal strength of the first data if the source address matches the desired address, and adjusts receiver sensitivity of the transceiver based on the first signal strength.

### BACKGROUND

The invention relates in general to wireless communication, and in particular, to a data transfer method and transceiver thereof.

IEEE 802.11 Wireless Local Area Network (WLAN) deploys Carrier Sense Multiple Access with Collision Avoidance (CSMA/CA) scheme as the data, access method. In CSMA/CA scheme the transmission media is shared by every station including every wireless client and AP in the network. Any station wishing to transmit must detect the condition of the radio channel in advance. The station may transmit data if the radio channel is free. If the channel is already occupied by a data transmission, the station has to wait until the channel is released again. The station employs a timer, referred as network allocation vector (NAV), to count the remaining time of the ongoing data transmission, such that it can attempt to send a frame after NAV is zero. The duration of channel occupation is referred as “Busy Medium” period.

To prevent two stations sending frames simultaneously, CSMA/CA scheme employs a random backoff counter at each station to further delay a random period so that data collision of the two stations is minimized. The station can attempt to transmit a frame upon elapse of the random backoff period.

FIG. 1 illustrates a system diagram of a wireless network, comprising first station STA1, second station STA2, third station STA3, reception coverage 10, reception coverage 12, and reception coverage 14,.

Referring to FIG. 1, if reception coverage 10 of the first station STA1 includes the second station STA2 but not the third station STA3, a problem known as “hidden node” may occur when both stations STA1 and STA3 transmit data to station STA2 simultaneously, and station STA2 may receive corrupted data.

On the other hand, if the reception coverage 10 of the first station STA1 includes both stations STA2 and STA3 when station STA1 only wishes to communicate with station STA2, the first station STA1 may detect the unwanted data from station STA3, and trigger the CSMA/CA mechanism, resulting in power waste for receiving the corrupted data, further delay due to network allocation vector counter and random backoff counter, and performance degradation.

Thus a data transfer method and transceiver circuit for wireless communication is proposed.

### SUMMARY

The present invention is directed to a data transfer method and transceiver circuit for wireless communication.

According to one embodiment of the invention, the transceiver comprises an antenna, and a receiving module. The antenna receives first data. The receiving module is coupled to the antenna, receives the first data, compares a source address of the first data with a desired address, determines first signal strength of the first data if the source address matches the desired address, and adjusts receiver sensitivity of the transceiver based on the first signal strength.

In accordance to another embodiment of the invention, a data transfer method comprises receiving first data, comparing a source address of the first data with a desired address, determining first signal strength of the first data if the source address matches the desired address, and adjusting receiver sensitivity of the transceiver based on the first signal strength.

### BRIEF DESCRIPTION OF THE DRAWINGS

The invention will become more fully understood from the detailed description, given hereinbelow, and the accompanying drawings. The drawings and description are provided for purposes of illustration only and, thus, are not intended to be limiting of the present invention.

FIG. 1 illustrates a system diagram of a wireless network.

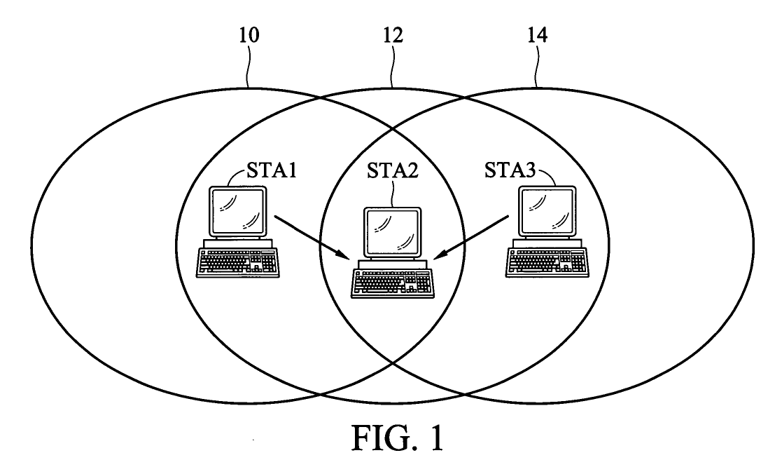

FIG. 2 is a block diagram of an exemplary transceiver in the invention.

FIG. 3 is a flowchart of an exemplary data transfer method of the invention, incorporating the transceiver in FIG. 2.

FIG. 4 plots Signal-to-Noise Ratio (SNR) against Packet Error Rate (PER) of data, according to an embodiment incorporating the wireless system in FIG. 2 and the data transfer method in FIG. 3.

FIG. 5 plots Signal-to-Noise Ratio (SNR) against Packet Error Rate (PER) of data, according to an embodiment incorporating the wireless system in FIG. 2 and the data transfer method in FIG. 3.

### DETAILED DESCRIPTION

For simplicity, while this disclosure of the invention is incorporated into an IEEE 802.11 Wireless Local Area Network (WLAN) under Infrastructure Mode, the circuitry and method disclosed may also find application in Adhoc Mode or other systems, and those skilled in the art may make modifications where appropriate based on the principle of the invention.

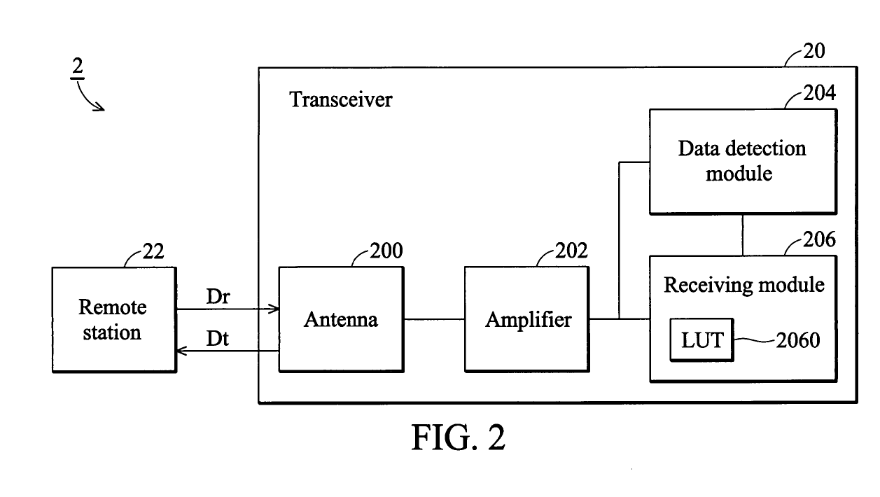

FIG. 2 is a block diagram of an exemplary transceiver in the invention, comprising antenna 200, amplifier 202, data detection module 204, and receiving module 206. Antenna 200 is coupled to amplifier 202, subsequently to data detection module 204 and receiving module 206.

Antenna 200 receives first data Dr from remote station 22 via a transmission channel, then delivers to amplifier 202. Remote station 22 may be an access point. Amplifier 202 amplifies first data Dr by amplifier gain G, and in turn passes to receiving module 206 and data detection module 204.

Data detection module 204 detects first data Dr through carrier sense (CS) or energy detection (ED), and enables receiving module 206 upon detection. Data detection module 204 may be an energy detector comparing channel energy in the transmission channel against an energy detection threshold Eth, such that the presence of first data Dr can be identified if the channel energy exceeds energy detection threshold Eth. Energy detection threshold Eth is adjustable to a required receiver sensitivity of receiver 20.

Receiving module 206 receives and demodulates first data Dr to the first data Dr, with a data frame format compliant with Media Access Control (MAC) layer in IEEE 802.11 specification, in which a source address of remote station 22 is specified. Receiving module 206 then compares the source address of the first data with a desired address, determines first signal strength of the first data if the source address matches the desired address, and adjusts receiver sensitivity of the transceiver to a target sensitivity based on the first signal strength.

The desired address is the address of remote station 22. The signal strength may be measured in Received Signal Strength Indicator (RSSI), a measure of received signal strength at antenna 200.

Receiving module 206 may include a lookup table 2060 (LUT) containing lookup signal strength and corresponding lookup sensitivity. The target sensitivity is decided through looking up the lookup signal strength of lookup table 2060 with the first signal strength, and find the corresponding lookup sensitivity as the target strength.

Data detection module 204 sets energy detection threshold Eth that the signal strength of data Dr must meet to achieve target packet error rate Pe. If the signal power is lower than energy detection threshold Eth, the minimum achievable packet error rate Pr will be increased to exceed packet error rate Pe. The receiver sensitivity may be adjusted by altering energy detection threshold Eth of the data detection circuit, or by altering reception gain G of amplifier 202.

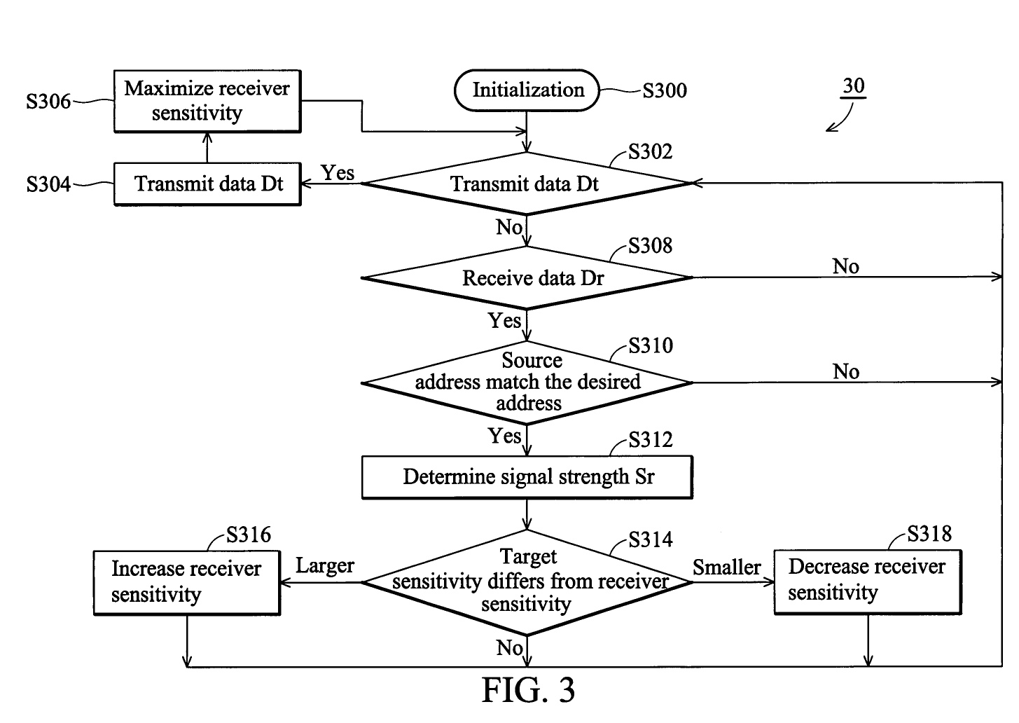

FIG. 3 is a flowchart of an exemplary data transfer method of the invention, incorporating the transceiver in FIG. 2.

Upon initialization in step S300, data transfer method 40 determines if transceiver 20 wishes to transmit data Dt to remote station 22 in step S302. Since in CSMA/CA transmission scheme, transceiver 20 detects requests access to a transmission channel prior to data reception.

In step S304, the receiver sensitivity of transceiver 20 is maximized prior to data transmission to remote station 22, such that transceiver 20 can detect Busy Medium in the transmission channel, if any, is present before transmitting data Dt in step S306.

Next in step S308, data detection module 204 determines if antenna 200 receives data Dr from the transmission channel. In absence of data Dr data transfer method 40 loops back to step S302, so that transceiver 20 may transmit data Dt to request transmission channel again. If data Dr is received at antenna 200, passed through amplifier 202 to receiving module 206 to continue step S310.

In step S310, receiving module 206 retrieves the source address from data Dr, and compares the source address with a desired address corresponding to remote station 22. Match of the source address and the desired address suggests transceiver 20 picking up correct data Dr from remote station 22, thus data transfer method 40 continues at step S312, otherwise it routes back to step S302.

In step S312, since transceiver 20 has obtained the correct data Dr, receiving module 206 determines signal strength Sr (first signal strength) of data Dr, thereby adjusting receiver sensitivity of transceiver 20.

In step S314, receiving module 206 decides a target sensitivity corresponding to signal strength Sr based on lookup table 2060. If the target sensitivity exceeds the receiver sensitivity, data transfer method 40 moves to step S316, if the target sensitivity is less than the receiver sensitivity, data transfer method 40 continues at step S318, the target sensitivity is just the receiver sensitivity, data transfer method 40 loops back to step S302.

In step S316, the receiver sensitivity is increased, such that data Dr from remote station 22 can be detected at a lower packet error rate. The receiver sensitivity may be increased via rising energy detection threshold Eth, or lowering amplifier gain G of amplifier 202. Upon completion of step S316, data transfer method 40 circles back to step S302, such that transceiver 20 receives subsequent data Dr with higher receiver sensitivity.

In step S318, the receiver sensitivity is decreased, 400402so that data beyond remote station 22 cannot be detected. The receiver sensitivity may be decreased via lowering energy detection threshold Eth, or increasing amplifier gain G of amplifier 202.

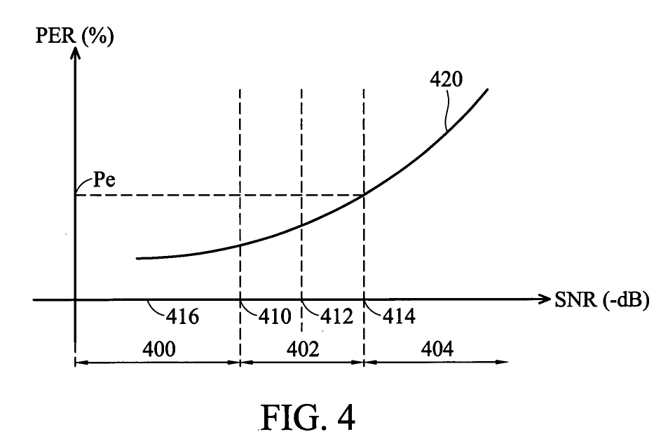

FIG. 4 plots Signal-to-Noise Ratio (SNR) against Packet Error Rate (PER) for the first data Dr in transceiver 20, according to an embodiment incorporating the wireless system in FIG. 2 and the data transfer method in FIG. 3. FIG. 4 shows an exemplary method of receiver sensitivity adjustment by altering energy detection threshold Eth, and comprises window 400, window 402, window 404, threshold 410, threshold 412, threshold 414, threshold 416, and signal 420.

Energy detection threshold window 402 represents a threshold range adjustable by energy detection threshold Eth, such that only signal strength Sr of received data Dr exceeding which can be detected by data detection module 204. As energy detection threshold Eth approaches threshold 410 direction (leftwards), signal strength Sr has to be stronger to be recognized in data detection module 204, i.e. data Dr with weaker signal strength Sr are ignored, less data Dr are detectable in transceiver 20, and lower receiver sensitivity is resulted in. Accordingly, if energy detection threshold Eth is moved towards threshold 414 direction, more data Dr become detectable in transceiver 20, leading to higher receiver sensitivity.

Upon initialization in step S300, energy detection threshold Eth is set at threshold 412 and amplifier gain G is fixed, method 40 determines transfer mode of transceiver 20 in step S302, maximizes the receiver sensitivity by altering energy detection threshold Eth to threshold 414, such that more data Dr become detectable in step S304, transmitting data Dt in step S306, determines if antenna 200 receives data Dr in step S308, compares the source address with the desired address in step S310, detects signal strength Sr at threshold 416, determines threshold 416 (signal strength Sr) is higher than threshold 414 (energy detection threshold Eth) in step S314, adjusts the receiver sensitivity to lower by altering energy detection threshold Eth towards threshold 416 in step S318, then loops back to transfer mode detection in step S302.

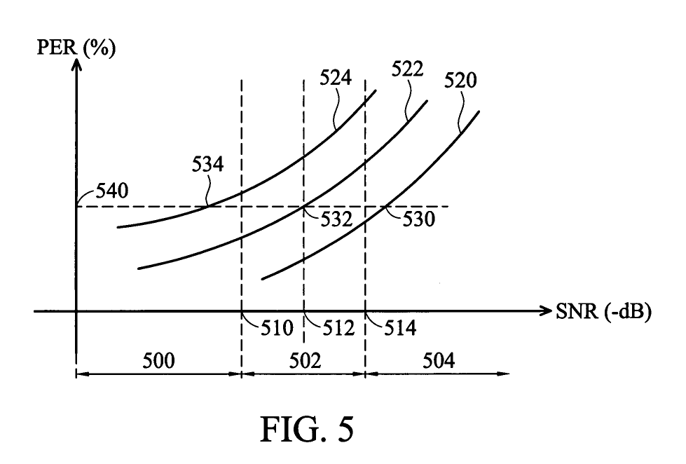

FIG. 5 plots Signal-to-Noise Ratio (SNR) against Packet Error Rate (PER) for the first data Dr in transceiver 20, according to an embodiment incorporating the wireless system in FIG. 2 and the data transfer method in FIG. 3. FIG. 5 shows an effect of adjusting receiver sensitivity by altering amplifier gain G, and comprises window 500, window 502, window 504, threshold 510, threshold 512, threshold 514, gain 520, gain 522, gain 524, signal strength 530, signal strength 532, signal strength 534, and achievable PER 540.

Referring to FIG. 5, gain 520 is lower than gain 522, subsequently lower than gain 524. Data Dr has a achievable PER 540, and Signal strength Sr has to exceed energy detection threshold Eth to be detected by data detection module 204. As amplifier gain G approaches gain 520 direction (rightwards), signal strength moves towards energy detection threshold Eth, i.e. data Dr become weaker, less data Dr are detectable in transceiver 20, and lower receiver sensitivity is resulted in. Accordingly, if amplifier gain G is moved towards threshold 524 direction, more data Dr become detectable in transceiver 20, leading to higher receiver sensitivity.

Upon initialization in step S300, energy detection threshold Eth is set at threshold 512 and amplifier gain G is at gain 522, method 40 determines transfer mode of transceiver 20 in step S302, maximizes the receiver sensitivity by altering amplifier gain G to gain 524, such that more data Dr become detectable in step S304, transmitting data Dt in step S306, determines if antenna 200 receives data Dr in step S308, compares the source address with the desired address in step S310, detects signal strength 534 at gain 524, determines signal strength 534 (gain 524) is stronger than threshold 512 (energy detection threshold Eth) in step S314, adjusts the receiver sensitivity to lower by altering amplifier gain G towards gain 520 in step S318, then loops back to transfer mode detection in step S302.

In yet another embodiment of the invention incorporating the wireless system in FIG. 2, the data transfer method in FIG. 3, the receiver sensitivity adjustment in FIGS. 4 and 5. Method 40 sets Energy detection threshold Eth at threshold 512 and amplifier gain G at gain 522 in step S300, determines transfer mode of transceiver 20 in step S302, maximizes the receiver sensitivity by altering amplifier gain G to gain 524 and energy detection threshold Eth to threshold 414, such that more data Dr become detectable in step S304, transmitting data Dt in step S306, determines if antenna 200 receives data Dr in step S308, compares the source address with the desired address in step S310, detects signal strength Sr, determines threshold 616 (signal strength Sr) is higher than threshold 512 (energy detection threshold Eth) in step S314, adjusts the receiver sensitivity to lower by altering amplifier gain G towards gain 520 and energy detection threshold Eth towards threshold 416 in step S318, then loops back to transfer mode detection in step S302.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data transfer method of a transceiver, comprising:
receiving first data;
comparing a source address of the first data with a desired address;
determining first signal strength of the first data if the source address matches the desired address; and
adjusting receiver sensitivity of the transceiver based on the first signal strength.

2. The data transfer method of claim 1, wherein the adjusting step comprises:
deciding a target sensitivity corresponding to the first signal strength; and
changing the receiver sensitivity to the target sensitivity.

3. The data transfer method of claim 2, further comprising a lookup table containing lookup signal strength and corresponding lookup sensitivity, and wherein the deciding step comprises looking up the lookup table with the first signal strength for the target sensitivity.

4. The data transfer method of claim 1, further comprising maximizing the receiver sensitivity upon transmitting a second data from the transceiver.

5. The data transfer method of claim 1, wherein the receiver sensitivity is adjusted by altering an energy detection threshold of the transceiver.

6. The data transfer method of claim 1, wherein the receiver sensitivity is adjusted by altering a reception gain of the transceiver.

7. The data transfer method of claim 1, wherein the signal strength is measured by Received Signal Strength Indicator (RSSI).

8. A transceiver, comprising:
an antenna receiving first data;
a receiving module coupled to the antenna, receiving the first data, comparing a source address of the first data with a desired address, determining first signal strength of the first data if the source address matches the desired address, and adjusting receiver sensitivity of the transceiver based on the first signal strength.

9. The transceiver of claim 9, wherein the receiving module adjusts by deciding a target sensitivity corresponding to the first signal strength, and changing the receiver sensitivity to the target sensitivity.

10. The transceiver of claim 11, wherein the receiving module further comprises a lookup table containing lookup signal strength and corresponding lookup sensitivity, and wherein the data detection circuit looks up the lookup table with the first signal strength for the target sensitivity.

11. The transceiver of claim 9, wherein the receiving module further maximizes the receiver sensitivity upon transmitting a second data from the antenna.

12. The transceiver of claim 9, further comprising a data detection circuit coupled to the antenna and the receiving module, and wherein the receiver sensitivity is adjusted by altering an energy detection threshold of the data detection circuit.

13. The transceiver of claim 9 further comprising an amplifier, and wherein the receiver sensitivity is adjusted by altering a reception gain of the amplifier.

14. The transceiver of claim 9, wherein the signal strength is measured by Received Signal Strength Indicator (RSSI).
